(19) United States
(12) Patent Application Publication
(10) Pub. No.: US 2009/0216833 A1
(43) Pub. Date: Aug. 27, 2009

(54) System and method for using a USB device of a client under a client-server architecture

(76) Inventors: Chih-Wei Chen, Taipei City (TW); Hsiao Fen Lu, Taipei City (TW)

Correspondence Address: Chih Feng Yeh;BRIAN M. MCINNIS, 12th Floor, Ruttonjee House, 11 Duddell Street, Hong Kong, HK

(21) Appl. No.: 12/155,856

(22) Filed: Jun. 11, 2008

(30) Foreign Application Priority Data
Feb. 25, 2008 (TW) 97106509

(51) Int. Cl. G06F 15/16; G06F 3/00

(52) U.S. Cl. 709/203; 710/16

(57) ABSTRACT

A system and method for using a USB device of a client under a client-server architecture, applying to clients of Thin-Client computers under a client-server architecture. Through information communications between the terminal server and the client, the system and method provide a end-user of a client for indirectly operating the USB device, which is linked to the client, via the terminal server under the client-server architecture.

### RELATED APPLICATIONS

This application claims priority to Taiwan Application Serial Number 97106509, filed Feb. 25, 2008, which is herein incorporated by reference.

### BACKGROUND

1. Field of Invention

The present invention relates to a system and method for using a USB device of a client under a client-server architecture. More particularly, the present invention relates to a system and method for using a USB device under a client-server architecture with Thin-Client computers of clients.

2. Description of Related Art

A Thin-Client is a client computer or client software in client-server architecture networks which depends primarily on the central server for processing activities, and mainly focuses on conveying input and output between the user and the remote server. In contrast, a thick or fat client does as much processing as possible and passes only data for communications and storage to the server.

The client-server architecture with Thin Client computers manage with centralizing administration, applying with simplified hardware without containing a hard disk, a CD-ROM drive and so on. Due to the easily managing advantages for the MIS of an enterprise and also benefits to the enterprise network overall security, the products of Thin Client computers start to catch the enterprise users' attention. Much more important, the cost of managing the client-server architecture with Thin Client computers is lower than equipping with the commercial personal computers, and also the maintenance of hardware will be easier. Because all application programs processed at the Thin Client are installed in a server and executed by which, the Thin Client does not require installing any application programs. Therefore, it can prevent an employee installing illegal software by himself, and avoid the hard disk damages or data retrieving errors.

Nevertheless, the locations of the client and the terminal server might be far from each other. If a client user needs to use the peripheral devices such as a printer, a scanner, a USB CD-ROM drive, or any other USB storage devices, he has to go to the terminal server to operate or to acquire his documents by himself, such as operating paper scanning or drawing printed documents. Therefore, there is still some inconvenience of applying with the client-server architecture with Thin Client computers.

### SUMMARY

For this reason, the present invention provides a system and method for using a USB device of a client under a client-server architecture, applying to a client which is a Thin-Client computer under a client-server architecture. Through information communications between the terminal server and the client, the system and method provide a client user for indirectly operating the USB device linked to the client via the terminal server.

The main idea to this invention is to present a system for using a USB device of a client under a client-server architecture, comprising a network area including the Local Area Network (LAN) or the Wide Area Network (WAN); a terminal server, comprising an operating system of a client-server architecture and processing all data under the client-server architecture; a client, comprising a USB port for inserting a USB device, wherein the client is linked to the terminal server via the network area, and data in the client is processed by the operating system in the terminal server; a first USB driving module, disposed in the client, and when the USB device is inserted into the USB port, the first USB driving module sends a USB signal packet to the terminal server; and a second USB driving module, disposed in the terminal server, and providing for initiating the USB device in accordance with the received USB signal packet for the client to operate the USB device indirectly via the terminal server.

The other idea to this invention is to present a method for using a USB device of a client under a client-server architecture, comprising following steps: (a)detecting if a USB device inserts into a USB port by a first USB driving module of a client; (b)retrieving the hardware information of the USB device by the first USB driving module; (c)sending a USB signal packet to a terminal server by the first USB driving module; (d)detecting if a second USB driving module receives the USB signal packet sent from the first USB driving module; (e)initiating the USB device of the client in accordance with the USB signal packet; and (f)generating an I/O command, providing the client to operate the USB device.

### BRIEF DESCRIPTION OF THE DRAWINGS

The invention can be more fully understood by reading the following detailed description of the embodiment, with reference made to the accompanying drawings as follows:

FIG. 1 is the block diagram of the system for using a USB device of a client under a client-server architecture of this invention; and

FIG. 2 is the flowchart of the method for using a USB device of a client under a client-server architecture of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

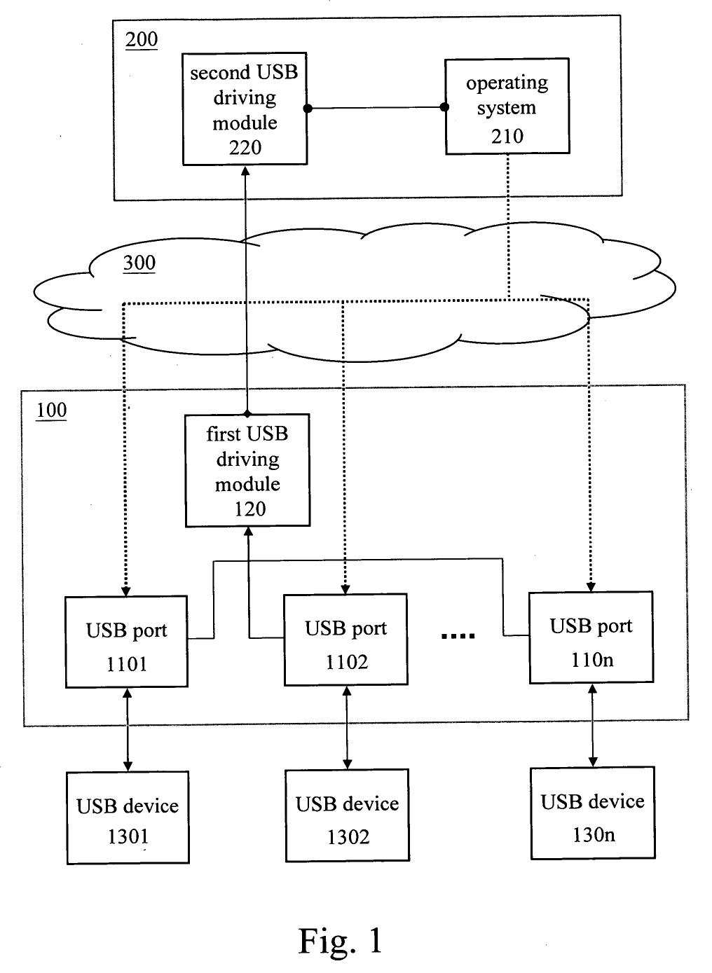

Refer to FIG. 1. FIG. 1 is the block diagram of the system for using a USB device of a client under a client-server architecture of this invention. As shown in FIG. 1, the system for using a USB device of a client under a client-server architecture of this invention comprises a client 100, a terminal server 200, a network area 300, a first USB driving module 120 of the client 100, and a second USB driving module 220 of terminal server 200. The terminal server 200 comprises an operating system 210 of a client-server architecture and processing all data under the client-server architecture. The client 100 comprises USB port 1101˜110n, for inserting USB device 1301˜130n. The client 100 is linked to the terminal server 200 via the network area 300, and data in the client 100 is processed by the operating system 210 in the terminal server 200. The client 100 and the terminal server 200 communicate with the Remote Desktop Protocol (RDP). The network area 300 is the Local Area Network (LAN) or the Wide Area Network (WAN). Besides, the first USB driving module 120 is disposed in the client 100, and when one of USB device 1301˜130n is inserted into one of USB port 1101˜110n, the first USB driving module 120 will read the hardware information of USB device 1301˜130n and send a USB signal packet to the terminal server 200, wherein the USB signal packet comprises following information: client 100 address, the communication port of client 100, USB port 1101˜110n for inserting USB device 1301˜130n, and relative hardware information of USB device 1301˜130n. The second USB driving module 220 is disposed in the terminal server 200, and provides for initiating the USB device 1301˜130n in accordance with the received USB signal packet. The second USB driving module 220 also provides for generating an I/O command, which is for the client 100 to operate the USB device 1301˜130n indirectly via the terminal server 200, in the operating system 210 of the terminal server 200. The above-mentioned USB device 1301˜130n refers to hardware devices with USB ports, such as a printer, a scanner, a USB CD-ROM drive, or any other USB storage devices.

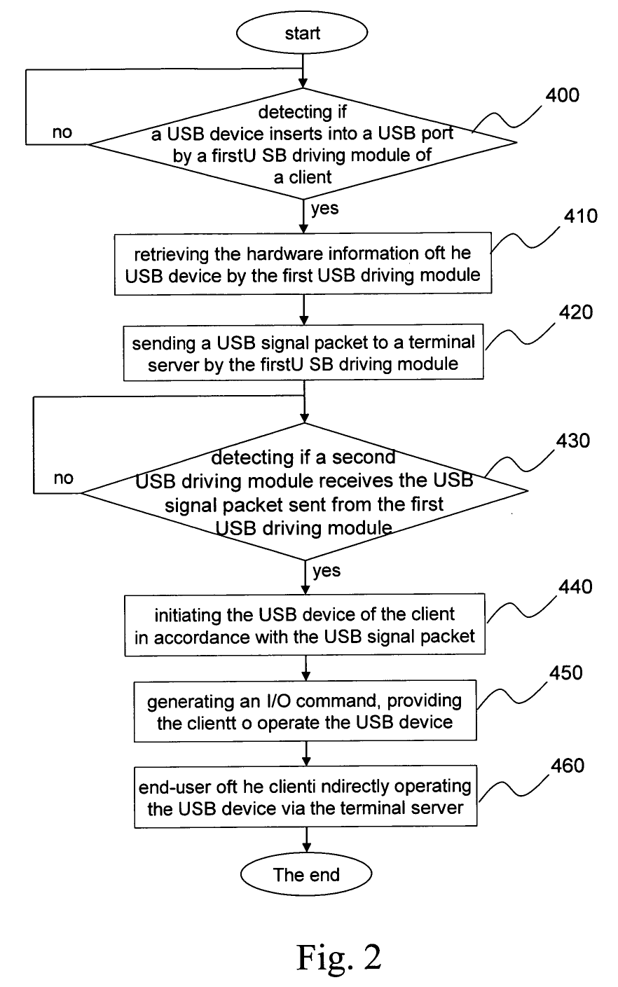

Refer to FIG. 2. FIG. 2 is the flowchart of the procedure for using a USB device of a client under a client-server architecture of this invention. As shown in FIG. 2, firstly, the first USB driving module 120 of client 100 detects if USB device 1301 inserts into USB port 1101 (Step 400). If the insertion of USB device 1301 is not detected in Step 400, the detecting procedure continues. But If the insertion of USB device 1301 is detected in Step 400, first USB driving module 120 retrieves the hardware information of USB device 1301 (Step 410). Then, client 100 sends a USB signal packet to terminal server 200 by the first USB driving module 120 (Step 420). And then, second USB driving module 220 detects if receiving the USB signal packet sent from first USB driving module 120 (Step 430). In Step 430, if second USB driving module 220 of terminal server 200 does not receive the USB signal packet, the detecting continues. But if second USB driving module 220 receives the USB signal packet in Step 430, the system initiates USB device 1301 of client 100 in accordance with the USB signal packet (Step 440). During the initiating procedure, the operating system 210 generates an I/O command, providing client 100 to operate the USB device 1301 (Step 450). Finally, a client user can indirectly operate the USB device 1301 of the client 100 via terminal server 200 (Step 460). Then the procedure of this invention ends up.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A system for using a USB device of a client under a client-server architecture, comprising:
a network area;
a terminal server comprising an operating system of a client-server architecture and processing all data under the client-server architecture;
a client comprising a USB port for inserting a USB device, wherein the client is linked to the terminal server via the network area, and data in the client is processed by the operating system in the terminal server;
a first USB driving module disposed in the client and when the USB device is inserted into the USB port, the first USB driving module sends a USB signal packet to the terminal server; and
a second USB driving module disposed in the terminal server and providing for initiating the USB device in accordance with the received USB signal packet for the client to operate the USB device indirectly via the terminal server.

2. The system for using a USB device of a client under a client-server architecture of claim 1, wherein the client is a Thin Client PC, which processes data through the terminal server.

3. The system for using a USB device of a client under a client-server architecture of claim 2, wherein the client and the terminal server communicate with the Remote Desktop Protocol (RDP).

4. The system for using a USB device of a client under a client-server architecture of claim 1, wherein the network area is the Local Area Network (LAN).

5. The system for using a USB device of a client under a client-server architecture of claim 1, wherein the network area is the Wide Area Network (WAN).

6. The system for using a USB device of a client under a client-server architecture of claim 1, wherein the USB device is the hardware which transmit data via the USB port.

7. The system for using a USB device of a client under a client-server architecture of claim 1, wherein the USB signal packet comprises following information: the client address, the communication port of the client, the USB port for inserting the USB device, and the hardware information of the USB device.

8. A method for using a USB device of a client under a client-server architecture, comprising following steps:
detecting if a USB device inserts into a USB port by a first USB driving module of a client;
retrieving the hardware information of the USB device by the first USB driving module;
sending a USB signal packet to a terminal server by the first USB driving module;
detecting if a second USB driving module receives the USB signal packet sent from the first USB driving module;
initiating the USB device of the client in accordance with the USB signal packet; and
generating an I/O command, providing the client to operate the USB device.

9. The method for using a USB device of a client under a client-server architecture of claim 8, wherein the terminal server and the client link within a network area, which is selected from a Local Area Network (LAN) or a Wide Area Network (WAN).

10. The method for using a USB device of a client under a client-server architecture of claim 8, wherein the client is a Thin Client PC, which processes data through the terminal server.

11. The method for using a USB device of a client under a client-server architecture of claim 10, wherein the client and the terminal server communicate with the Remote Desktop Protocol (RDP).

12. The method for using a USB device of a client under a client-server architecture of claim 8, wherein the USB device is the hardware which transmit data via the USB port.

13. The method for using a USB device of a client under a client-server architecture of claim 8, wherein the USB signal packet comprises following information: the client address, the communication port of the client, the USB port for inserting the USB device, and the hardware information of the USB device.

14. The method for using a USB device of a client under a client-server architecture of claim 8, wherein the I/O command, which is set up at the terminal server, provides the client for operating the USB device indirectly via the terminal server.
